(19) United States
(12) Patent Application Publication
(10) Pub. No.: US 2003/0036916 A1
(43) Pub. Date: Feb. 20, 2003

(54) Merchandise information providing method, merchandise information providing program, recording medium therefor and merchandise information providing server

(75) Inventor: Akihiko Kitajima, Yokohama (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/102,978

(22) Filed: Mar. 22, 2002

(30) Foreign Application Priority Data
Aug. 15, 2001 (JP) 2001-246655

(51) Int. Cl. G06F 17/60

(52) U.S. Cl. 705/1

(57) ABSTRACT

A merchandise information providing method of obtaining merchandise information relating to merchandise from a manufacturer and providing the obtained merchandise information to a purchaser who purchases the merchandise includes: a purchase information storing step storing merchandise identification information identifying the merchandise that the purchaser purchases and purchaser identification information identifying the purchaser in a purchase information storing part in a mutually associating manner; a merchandise information obtaining step searching and obtaining merchandise information corresponding to the merchandise identification information from a merchandise information storing part having the merchandise information relating to the merchandise that the manufacturer provides; and a merchandise information providing step providing the obtained merchandise information to a terminal for the purchaser corresponding to the purchaser identification information.

### BACKGROUND OF THE INVENTION

1. Field of the Invention

The present invention relates to merchandise information providing methods, merchandise information providing programs, recording media therefor and merchandise information providing servers, and more particularly, to a merchandise information providing method of providing a purchaser who purchases merchandise with merchandise information relating to the merchandise, a merchandise information providing program, a recording medium for recording the program and a merchandise information providing server.

2. Description of the Related Art

For example, manufacturers that manufacture products sell the manufactured products to purchasers (users, hereinafter) as merchandise. When an problem such as a defect is found with the sold merchandise, it is necessary for the manufactures to recall the defective merchandise from the users so as to eliminate the problem by replacing a part or the like.

Accordingly, when the problem is found with the sold merchandise, the manufactures have notified the users of the problem by using mass media such as newspapers, televisions and the like, and call for the recall of the defective merchandise to the users. The users have confirmed the problem notified by the manufacturers, and have asked the manufactures for eliminating the problem when the problem relates to the merchandise that the users have.

There are various kinds of problem, from important problem to minor problem, of which the users should be notified. However, when notifying the users of the problem by using the mass media such as the newspapers, televisions and the like, it has been necessary for the manufactures to bear cost of such as advertising rate irrespective of a level of the problem. That is, there has been a problem of imbalance of cost with respect to the problem. Further, there has been a problem in that certainty of distributing information is low when notifying the users of the problem using the mass media.

On the other hand, there has been a problem in that the users keep on using the merchandise having the problem such as a defect and second accident may occur when the users cannot confirm the problem notified by the manufactures. Additionally, although the users has been able to confirm the problem notified by the manufactures, it has been necessary for the users to confirm detailed information such as a model name in order to determine whether or not the problem relates to the merchandise that the users have.

Furthermore, when the problem exist in particular merchandise that is manufactured in a particular term or by a particular factory, it has been necessary for the purchasers of the merchandise to check purchasing time or serial numbers in order to confirm whether or not the merchandise that the users purchased have the problem.

### SUMMARY OF THE INVENTION

A general object of the present invention is to provide an improved and useful merchandise information providing method, merchandise information providing program, recording medium and merchandise information providing server in which the above-mentioned problems are eliminated.

A more specific object of the present invention is to provide a merchandise information providing method, merchandise information providing program, recording medium and merchandise information providing server which are able to easily and positively provide purchasers of merchandise with merchandise information relating to the merchandise.

In order to achieve the above-mentioned objects, there is provided according to one aspect of the present invention, a merchandise information providing method of obtaining merchandise information relating to merchandise from a manufacturer and providing the obtained merchandise information to a purchaser who purchases the merchandise, comprising: a purchase information storing step storing merchandise identification information identifying the merchandise that the purchaser purchases and purchaser identification information identifying the purchaser in a purchase information storing part in a mutually associating manner; a merchandise information obtaining step searching for and obtaining merchandise information corresponding to the merchandise identification information from a merchandise information storing part having the merchandise information relating to the merchandise that the manufacturer provides; and a merchandise information providing step providing the obtained merchandise information to a terminal for the purchaser corresponding to the purchaser identification information.

Additionally, there is provided according to another aspect of the present invention, a merchandise information providing software program for causing a computer to perform the following steps: storing merchandise identification information identifying merchandise that a purchaser purchases and purchaser identification information identifying the purchaser in a purchase information storing part in a mutually associating manner; searching for and obtaining merchandise information corresponding to the merchandise identification information from a merchandise information storing part having the merchandise information relating to the merchandise that a manufacturer provides; and providing the obtained merchandise information to a terminal for the purchaser corresponding to the purchaser identification information.

Additionally, there is provided according to another aspect of the present invention, a computer readable recording medium recording a merchandise information providing program for causing a computer to perform the following steps: storing merchandise identification information identifying merchandise that a purchaser purchases and purchaser identification information identifying the purchaser in a purchase information storing part in a mutually associating manner; searching for and obtaining merchandise information corresponding to the merchandise identification information from a merchandise information storing part having the merchandise information relating to the merchandise that a manufacturer provides; and providing the obtained merchandise information to a terminal for the purchaser corresponding to the purchaser identification information.

Further, there is provided according to another aspect of the present invention, a merchandise information providing server that obtains merchandise information relating to merchandise from a manufacturer and provides the obtained merchandise information to a purchaser who purchases the merchandise, comprising: a purchase information storing part storing merchandise identification information identifying the merchandise that this purchaser purchases and purchaser identification information identifying the purchaser in a mutually associating manner; a merchandise information obtaining part searching for and obtaining merchandise information corresponding to the merchandise identification information from a merchandise information storing part having the merchandise information relating to the merchandise that the manufacturer provides; and a merchandise information providing step providing the obtained merchandise information to a terminal for the purchaser corresponding to the purchaser identification information.

As mentioned above, according to the present invention, the manufacturer can improve certainty of information communication. In addition, the purchaser can easily and positively obtain the merchandise information relating to the merchandise that the purchaser purchased without being conscious of purchase history. Further, the third-party organization managing the purchase history of the purchaser can provide a novel service to at least the manufacture or the purchaser.

For example, the third-party organization can obtain the merchandise information relating to the merchandise that the purchaser purchased from one or more manufacturer, and can provide the obtained merchandise information to the purchaser. Additionally, the third-party organization can easily manage the purchase history of the purchaser by collecting the merchandise identification information and the purchaser identification information from, for example, the store of the merchandise.

Furthermore, according to the present invention, it is possible to determine whether or not the purchased merchandise has a problem by the date of purchase or the place of purchase when the merchandise manufactured in a particular term or by a particular factory has the problem.

Other objects, features and advantages of the present invention will become more apparent from the following detailed description when read in conjunction with the following drawings.

### BRIEF DESCRIPTION OF THE DRAWINGS

FIG. 1 is a schematic diagram of an embodiment of a system including a merchandise information providing server of the present invention;

FIG. 2 is a block diagram of an embodiment of the merchandise information providing server;

FIG. 3 is an example of a schematic diagram for explaining the principle of the present invention;

FIG. 4 is a flow chart of a first embodiment of a merchandise information providing method of the present invention;

FIG. 5 is a schematic diagram of an example of a merchandise purchase history information DB;

FIG. 6 is a schematic diagram of an example of a recall information DB;

FIG. 7 is a schematic diagram of an example of a code conversion table;

FIG. 8 is an illustrative drawing of an example of an inquiry result window;

FIG. 9 is a flow chart of a second embodiment of the merchandise information providing method of the present invention;

FIG. 10 is a schematic diagram of another example of the recall information DB;

FIG. 11 is a flow chart of a third embodiment of the merchandise information providing method of the present invention;

FIG. 12 is a flow chart of an example of a merchandise purchase history information entry process;

FIG. 13 is a schematic diagram of an example of a user information DB;

FIG. 14 is a schematic diagram of an example of a part number information DB;

FIG. 15 is a flow chart of an example of an entry process of recall information and code conversion information;

FIG. 16 is a flow chart of an another example of the entry process of recall information and code conversion information;

FIG. 17 is a flow chart for explaining the first half of a first embodiment of a recall information inquiry notification process;

FIG. 18 is a flow chart for explaining the latter half of the first embodiment of the recall information inquiry notification process;

FIG. 19 is a flow chart for explaining the first half of a second embodiment of the recall information inquiry•notification process;

FIG. 20 is a flow chart for explaining the latter half of the second embodiment of the recall information inquiry•notification process;

FIG. 21 is a flow chart for explaining the first half of a third embodiment of the recall information inquiry•notification process; and

FIG. 22 is a flow chart for explaining the latter half of the third embodiment of the recall information inquiry•notification process.

### DETAILED DESCRIPTION OF THE PREFERRED EMBODIMENTS

Next, a description will be given of embodiments of the present invention, by referring to the drawings. It should be noted that in this embodiment, a description will be given of a case where the users are notified of the recall information as an example of the merchandise information, however, any information relating to the merchandise will be applicable.

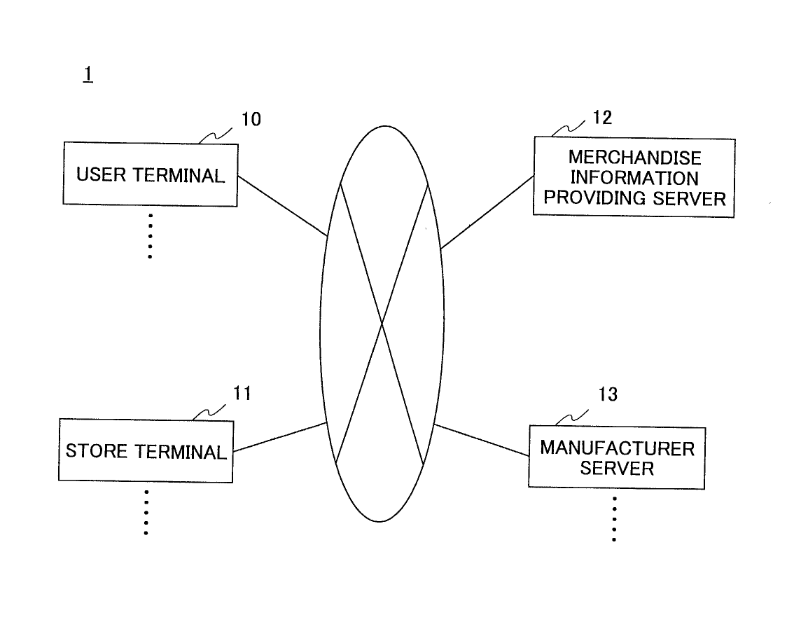

FIG. 1 is a schematic diagram of an embodiment of a system including a merchandise information providing server of the present invention. In the system in FIG. 1, one or more user terminal 10, one or more store terminal 11, a merchandise information providing server 12 and one or more manufacturer server 13 are connected through a network 14 such as the Internet, for example.

The user terminal 10 is operated by the user that purchased the merchandise, and has a function to communicate with the merchandise information providing server 12 through the network 14. Additionally, the store terminal 11 is operated by a salesperson of a seller of the merchandise or a store that accepts credit cards, and has a function to communicate with the merchandise information providing server 12 through the network 14.

For example, when the network 14 is the Internet, the user terminal 10 and the store terminal 11 are the terminals that can access the Internet, and have a function to browse a Web page stored in the merchandise information providing server 12.

The manufacturer server 13 is managed by the manufacturer that manufactures electrical goods, furniture, or the like, and has recall information of manufactured merchandise. The manufacturer server 13 stores and manages the recall information in a recall information database (recall information DB, hereinafter).

Additionally, the manufacturer server 13 has a function to communicate with the merchandise information providing server 12 through the network 14. The manufacturer server 13 has a search function that searches the recall information from the recall information DB as the need arises.

The merchandise information providing server 12 is managed by a third-party organization such as a consumer credit company or store. The merchandise information providing server 12 is provided with various information that is required in order to realize the merchandise information providing method of the present invention from the user terminal 10, the store terminal 11 and the manufacturer server 13.

The merchandise information providing server 12 manages merchandise purchase history information of the users, and at the same time, has a function to obtain the recall information corresponding to a designated merchandise from the manufacturer server 13. In addition, the merchandise information providing server 12 has a function to send the obtained recall information to the user terminal 11. For example, when the network 14 is the Internet, the merchandise information providing server 12 has a function to send a Web page to the user terminal 10 and the store terminal 11.

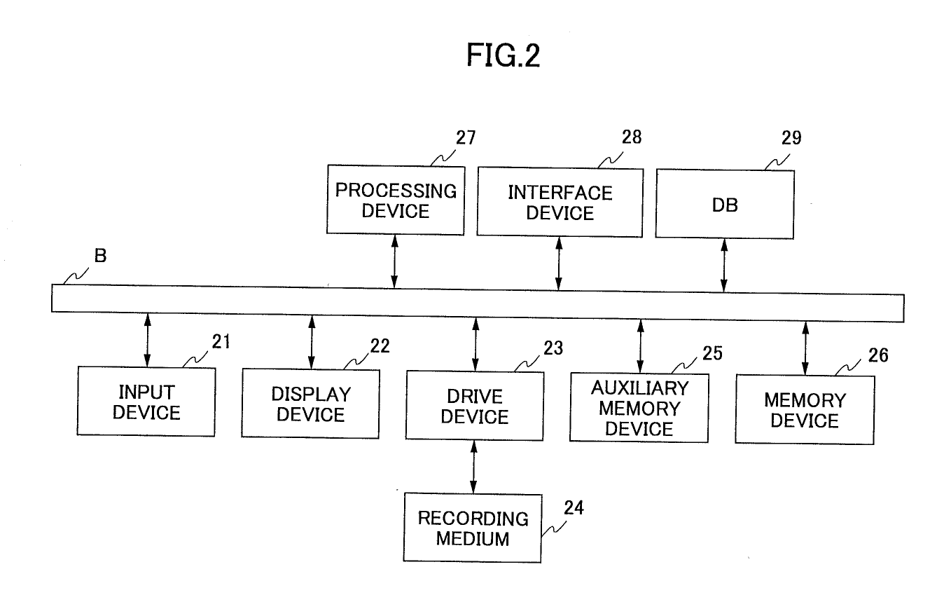

The merchandise information providing server 12 is structured as shown in FIG. 2, for example. FIG. 2 is a block diagram of an embodiment of the merchandise information providing server. The merchandise information providing server 12 in FIG. 2 includes an input device 21, a display device 22, a drive device 23, a recording medium 24, an auxiliary memory device 25, a memory device 26, a processing device 27, an interface device 28, and a database (DB, hereinafter) that are mutually connected through a bus B.

The input device 21 is structured by a keyboard and a mouse that are operated by a user of the merchandise information providing server 12, and is used for inputting various operating signal to the merchandise information providing server 12. The display device 22 displays various windows, data and the like that are necessary to operate the merchandise information providing server 12. The interface device 28 is an interface for connecting the merchandise information providing server 12 with the network 14, and is structured by such as a modem or router.

The DB 29 stores various information required for realizing the merchandise information providing method of the present invention such as a user information DB, a part number DB, a merchandise purchase history information DB, a code conversion table, a recall information DB, for example. Additionally, a description will be given later of the user information DB, the part number DB, the merchandise purchase history information DB, the code conversion table, the recall information DB.

A merchandise information providing program used by the merchandise information providing server 12 is provided by the recording medium such as a CD-ROM. As the recording medium 24, various types of recording media can be used. For example, a recording medium that records information optically, electrically or magnetically such as a flexible disk, a magnetic optical disk (MO) and the like, and a semiconductor memory that records the information electrically such as ROM, a flash memory, and the like.

The recording medium 24 recording the merchandise information providing program is set to the drive device 23. Then, the merchandise information providing program is installed to the auxiliary memory device 25 from the recording medium 24 through the drive device 23.

The auxiliary memory device 25 stores a necessary file, data and the like as well as the installed merchandise information providing program. The memory device 26 reads the merchandise information providing program from the auxiliary memory device 25 when the merchandise information providing server 12 is started up, and stores the merchandise information providing program read. The processing device 27 performs a process relating to the merchandise information providing server 12 according to the merchandise information providing program that is read by and stored in the memory device 26.

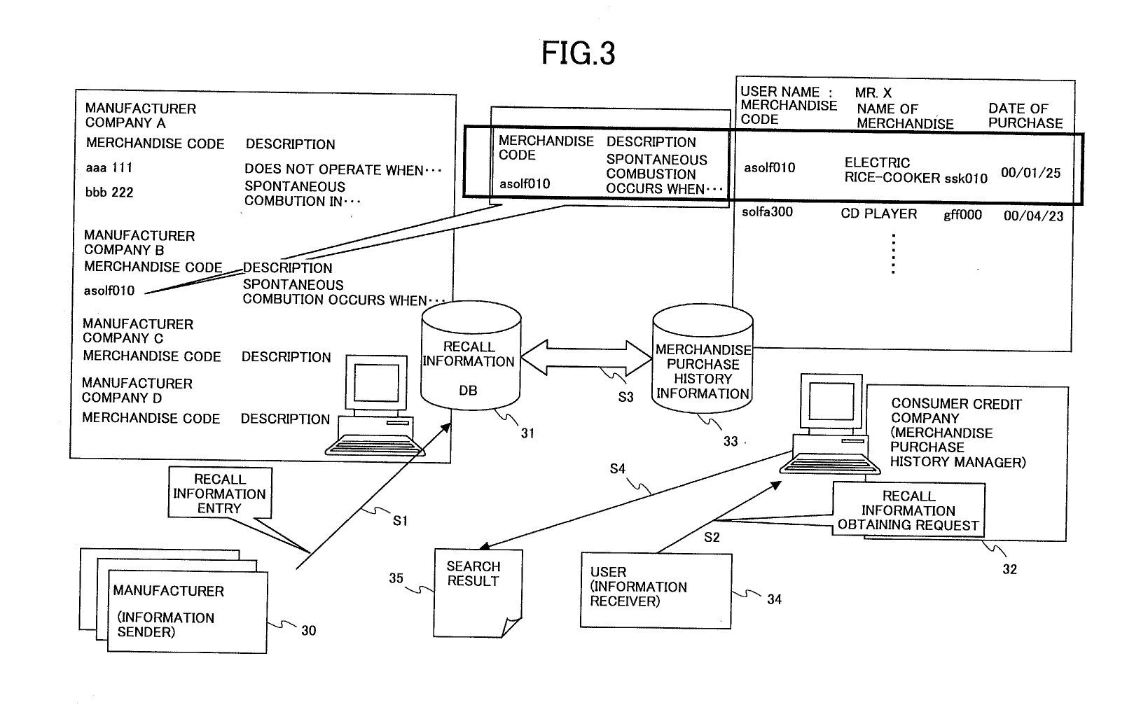

In the following, a description will be given of a process of a system 1 that realizes the merchandise information providing method of the present invention. First, in order to facilitate understanding of the present invention, a description will be given of a principle of the present invention, referring to FIG. 3. FIG. 3 shows a schematic configuration for explaining the principle of the present invention.

In step S1, a manufacturer 30 as an information sender enters the recall information in a recall information DB 31. The manufacturer 30 may enter the recall information in the recall information DB 31 every predetermined term (a day, for example), or may enter the recall information in the recall information DB 31 every time the problem such as the defect is found with the merchandise sold.

The recall information DB 31 includes fields such as a manufacturer code to recognize the manufacture, a merchandize code to recognize the merchandise, an problem, and the like. Further, a user, a consumer credit company and the like can access the recall information DB 31.

Additionally, a consumer credit company 32 as a merchandise purchase history manager enters the merchandise purchase history information in the merchandise purchase history information DB 33 and manages the merchandise purchase history information. The merchandise purchase history information DB 33 includes fields such as a user information, a merchandise code, a date of purchase, and the like. Further, the store or the store that accepts the credit cards, for example, provides the consumer credit company 32 with the user information, the merchandise code, the date of purchase and the like of the user that purchases the merchandise.

In step S2, a user 34 as an information receiver operates the user terminal 10, for example, and sends a recall information obtaining request to the consumer credit company 32. The merchandise information providing server 12 proceeds to step S3 subsequently to step S2 when receiving the recall information acquisition request.

The merchandise information providing server 12 of the consumer credit company 32 reads the merchandise purchase history information of the user that sent the recall information acquisition request from the merchandise purchase history information DB 33, and searches the recall information DB 31 regarding the merchandise code included in the read merchandise purchase history information as a key information.

When the same merchandise code as the merchandise code included in the merchandise purchase history information is stored in the recall information DB 31, it is realized that the recall information is provided for the merchandise that the user purchased. On the other hand, when the same merchandise code as the merchandise code included in the merchandise purchase history information is not stored in the recall information DB 31, it is realized that the recall information is not provided for the merchandise that the user purchased.

For example, in FIG. 3, the problem “spontaneous combustion occurs when . . . ” is obtained when searching the recall information DB 31 using the merchandise code “asolf010” as the key information. Further, when the recall information is not provided for the merchandise having the merchandise code “solfa300”, the problem is not obtained when searching the recall information DB 31 using the merchandise code “solfa300” as the key information.

After searching the recall information DB 31 using the all merchandise codes included in the merchandise purchase history information as the key information, the merchandise information providing server 12 of the consumer credit company 32 proceeds to step S4 subsequently to step s3.

In step S4, the merchandise information providing server 12 of the consumer credit company 32 sends a search result to the user terminal 10, for example. The search result includes a name of merchandise for which the recall information is provided, the problem, and the like.

Accordingly, the user can easily refer to or obtain the recall information relating to the merchandise purchased by the user without being conscious of the merchandise. In addition, since the user performs the recall information obtaining request at the user's own will, it is possible to reduce possibility of oversight of the recall information.

Additionally, it is possible for the manufacturer 30 to improve the certainty of information communication to the user that purchased the merchandise relating to the recall information by disclosing the recall information to the consumer credit company 32. Further, the consumer credit company 32 can provide a service of selecting and notifying the recall information relating to the merchandise that the user purchased. For this reason, it is possible for the consumer credit company 32 to differentiate itself from the other consumer credit companies.

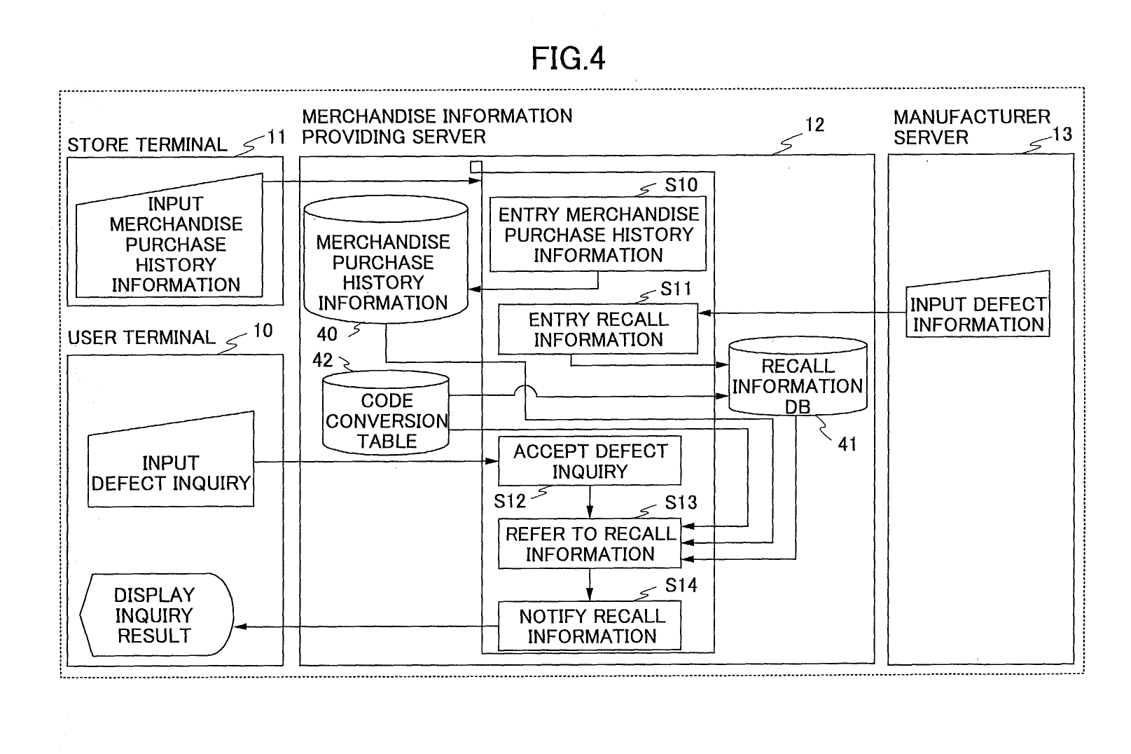

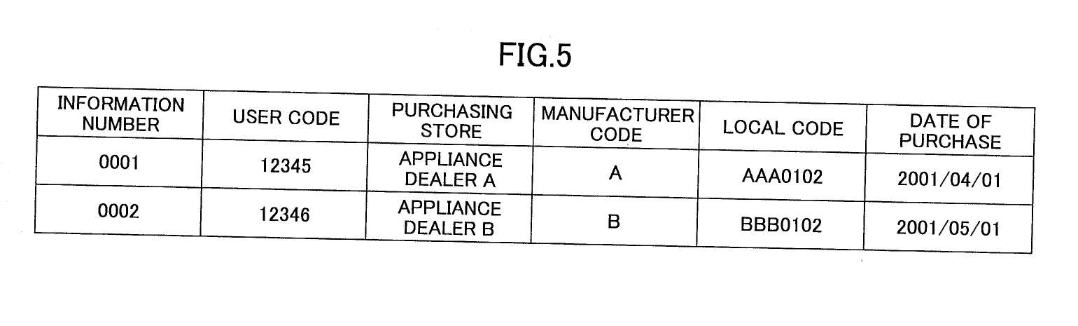

FIG. 4 is a flow chart of a first embodiment of the merchandise information providing method of the present invention. Step 10 is a merchandise purchase history information entry process. In step S10, the merchandise information providing server 12 receives the merchandise purchase history information from the store terminal 11. The merchandise information providing server 12 enters the input merchandise purchase history information in a merchandise purchase history information DB 40 as shown in FIG. 5.

FIG. 5 is a schematic diagram of an example of the merchandise purchase history information DB. The merchandise purchase history information DB 40 in FIG. 5 includes fields such as an information number, a user code, a purchasing store, a manufacturer code, a local code, a date of purchase and the like. Further, the field “local code” is merchandise identification information used by the consumer credit company for identifying the merchandise.

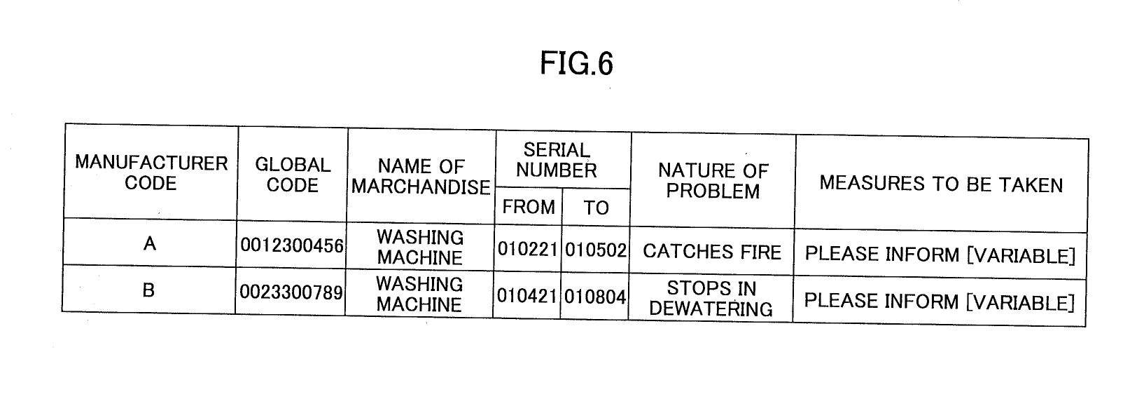

In step S11, the merchandise information providing server 12 receives defect information relating to the problem with the merchandise from the manufacturer server 13. The merchandise information providing server 12 enters the input defect information in a recall information DB 41 as shown in FIG. 6 as the recall information.

FIG. 6 is a schematic diagram of an example of the recall information DB. The recall information DB 41 in FIG. 6 includes fields such as a manufacturer code, a global code, a name of merchandise, a serial number, a nature of problem, measures to be taken and the like. The field “global code” is merchandise identification information used by the manufacturer for identifying the merchandise. Additionally, the field “nature of problem” is the problem of the merchandise. Further, the field “measures to be taken” is measures to cope with the problem of the merchandise.

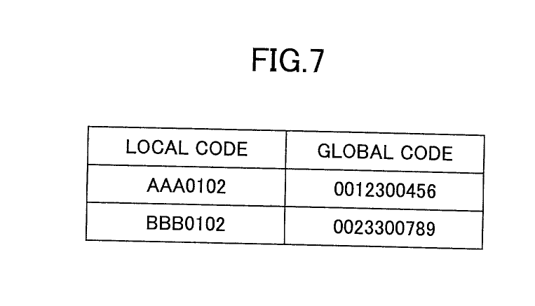

The merchandise information providing server 12 converts the global code into the local code using a code conversion table 42 as shown in FIG. 7, when receiving the global code from the manufacturer server 13. FIG. 7 is a schematic diagram of an example of the code conversion table.

The code conversion table 42 in FIG. 7 includes fields such as a local code and a global code. That is, the code conversion table 42 matches the local code to the global code. The merchandise information providing server 12 can convert the global code that is input by the manufacturer server 13 into the local code and can enter the local code to the recall information DB 41 by using the code conversion table 42.

Step 12 is a defect inquiry accepting process. In step S12, the merchandise information providing server 12 receives defect inquiry relating to the defect of the merchandise from the user terminal 10. The merchandise information providing server 12 accepts the input defect inquiry. Further, the merchandise information providing server 12 obtains a user code of the user that input the defect inquiry by an authorization process or the like.

In step S13, the merchandise information providing server 12 searches the merchandise purchase history information DB 40 using the user code obtained in step S12 as the key information, and obtains the local code corresponding to the user code. That is, the merchandise information providing server 12 obtains the local code of the merchandise purchased by the user.

The merchandise information providing server 12 converts the local code into the global code by using the code conversion table 42. The merchandise information providing server 12 searches the recall information DB 41 by using the converted global code as the key information, and obtains the recall information corresponding to the global code. That is, the merchandise information providing server 12 obtains the recall information of the merchandise purchased by the user.

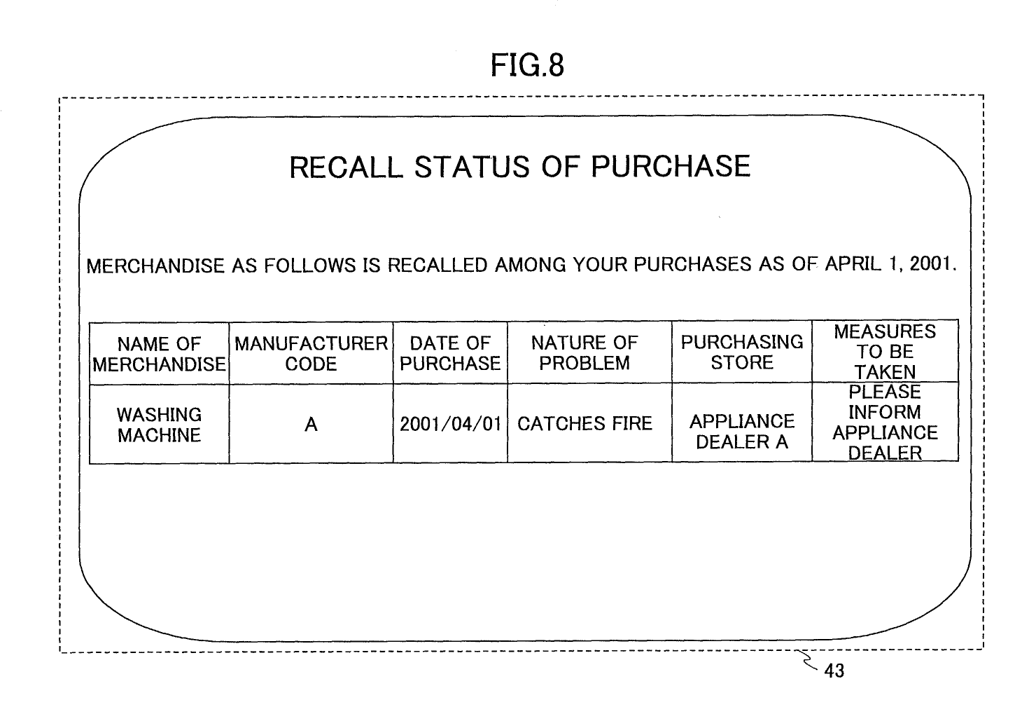

In step S14, the merchandise information providing server 12 notifies the user terminal 10 of the recall information obtained in step S13. The user terminal 10 displays the notified recall information as the inquiry result as shown in FIG. 8.

FIG. 8 is a schematic diagram of an example of an inquiry result window. The inquiry result window 43 of FIG. 8 displays fields such as a name of merchandise, a manufacturer code, a date of purchase, a nature of problem, a store where the merchandise is purchased, measures to be taken and the like. That is, the recall information is displayed in the inquiry result window when the recall information is provided for the merchandise that the user purchase in the past. Accordingly, it is possible for the user to easily refer to or obtain the recall information of the merchandise purchased by the user.

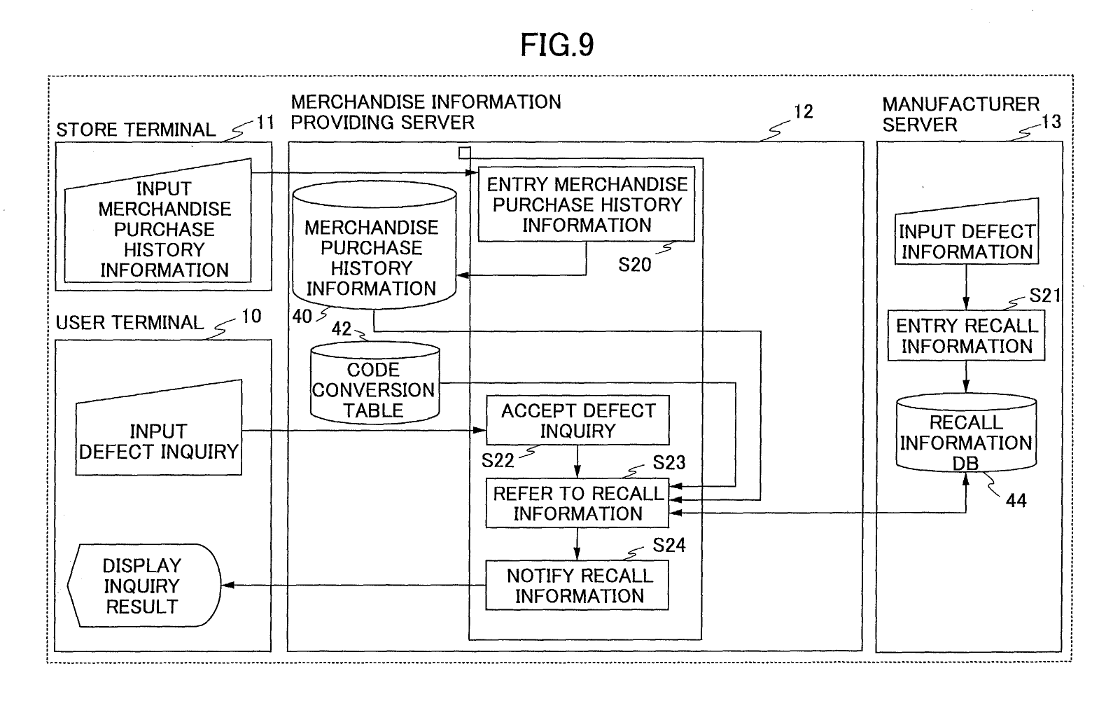

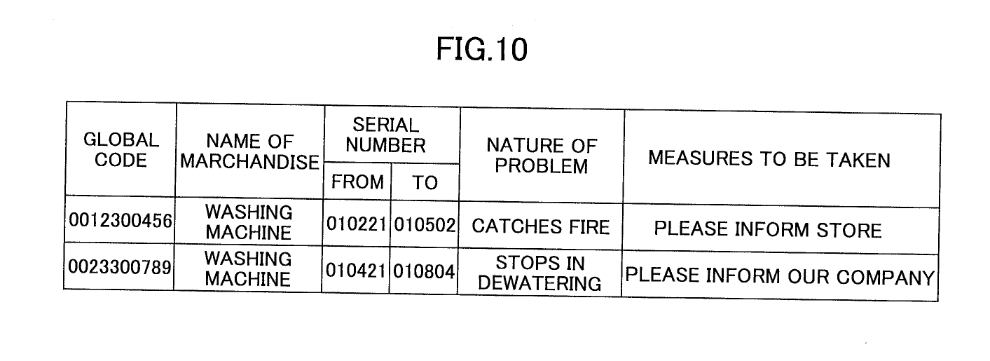

FIG. 9 is a flow chart of a second embodiment of the merchandise information providing method of the present invention. A merchandise purchase history information entry process of step S20 is the same as the merchandise purchase history information entry process of step S10. Thus, a description thereof will be omitted. In step S21, the manufacturer server 13 receives defect information relating to problems with the merchandise. The manufacturer server 13 enters the input defect information in a recall information DB 44 as shown in FIG. 10 as the recall information. The manufacturer manages the recall information DB 44.

FIG. 10 is a schematic diagram of another example of the recall information DB. The recall information DB 44 in FIG. 10 includes fields for a global code, a name of merchandise, a serial number, a nature of problem, measures to be taken and the like. Since the recall information DB 44 is managed by each manufacture, the recall information DB 44 does not include the field “manufacturer code” that is included in the recall information DB 41.

Further, a defect inquiry accepting process of step S22 is the same as the defect inquiry accepting process of step S12. Thus, a description thereof will be omitted. In step S23, the merchandise information providing server 12 searches the merchandise purchase history information DB 40 using the user code obtained in step S22 as the key information, and obtains the local code corresponding to the user code.

The merchandise information providing server 12 converts the local code obtained into the global code by using the code conversion table 42. The merchandise information providing server 12 can operate and refer to the recall information DB 44 that the manufacturer manages by using SQL (Structured Query Language), for example.

Accordingly, the merchandise information providing server 12 can search the recall information DB 44 using the converted global code as the key information, and can obtain the recall information corresponding to the global code. That is, the merchandise information providing server 12 can obtain the recall information of the merchandise purchased by the user. Further, a recall information notification process of step S24 is the same as a recall information notification process of step S14. Thus, a description thereof will be omitted.

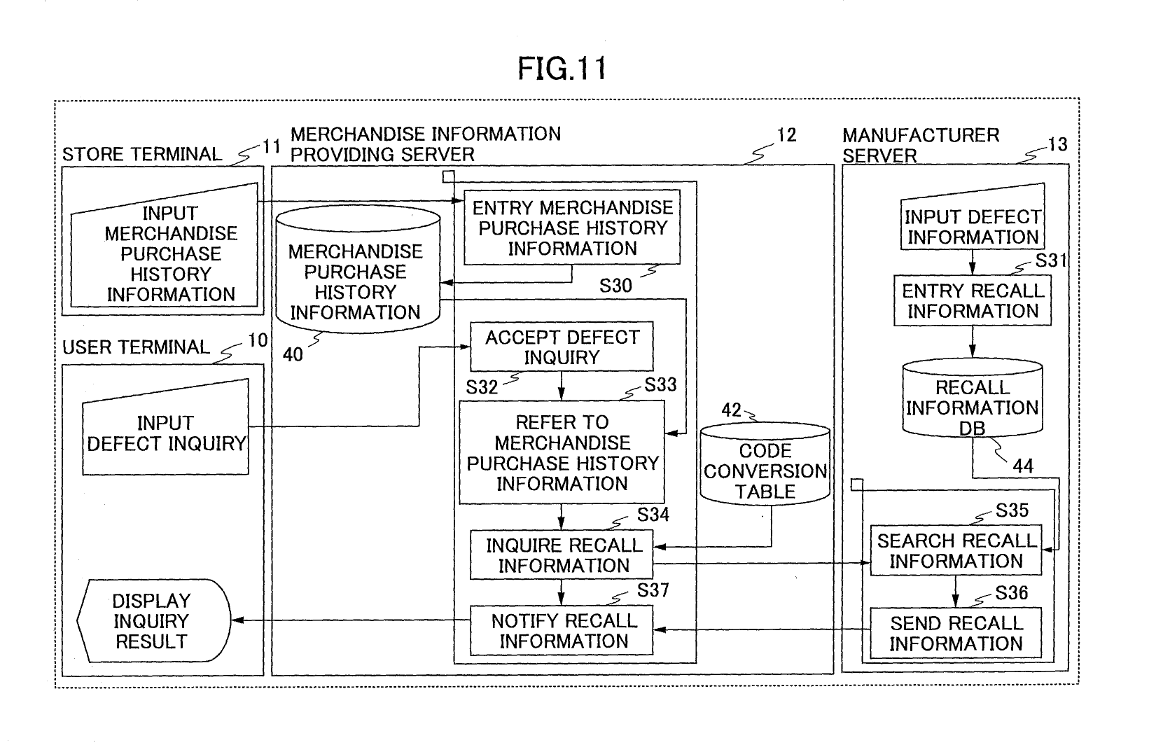

FIG. 11 is a flow chart of a third embodiment of the merchandise information providing method of the present invention. Further, a merchandise purchase history information entry process of step S30 is the same as the merchandise purchase history information entry process of step S10. A recall information entry process of step S31 is the same as a recall information entry process of step S21. A defect inquiry accepting process of step S32 is the same as a defect inquiry accepting process of step S12. Thus, a description thereof will be omitted.

In step S33, the merchandise information providing server 12 refers to the merchandise purchase history information DB 40, and obtains the local code corresponding to the user code obtained in step S32. That is, the merchandise information providing server 12 obtains the local code of the merchandise purchased by the user.

In step S34, the merchandise information providing server 12 converts the local code obtained into the global code by using the code conversion table 42. The merchandise information providing server 12 inquires of the manufacturer the recall information by sending the global code to the manufacturer server 13 as a search condition.

In step S35, the manufacturer server 13 searches the recall information DB 44 using the global code as the search condition (key information), and obtains the recall information corresponding to the global code as a search result. In step S36, the manufacturer server 13 sends the recall information obtained as the search result in step S35 to the merchandise information providing server 12.

In step S37, the merchandise information providing server 12 notifies the user terminal 10 of the recall information received from the manufacturer server 13. The user terminal 10 can display an inquiry result window 43 based on the recall information notified by the merchandise information providing server 12. The user can easily refer to or obtain the recall information of the merchandise purchased by the user.

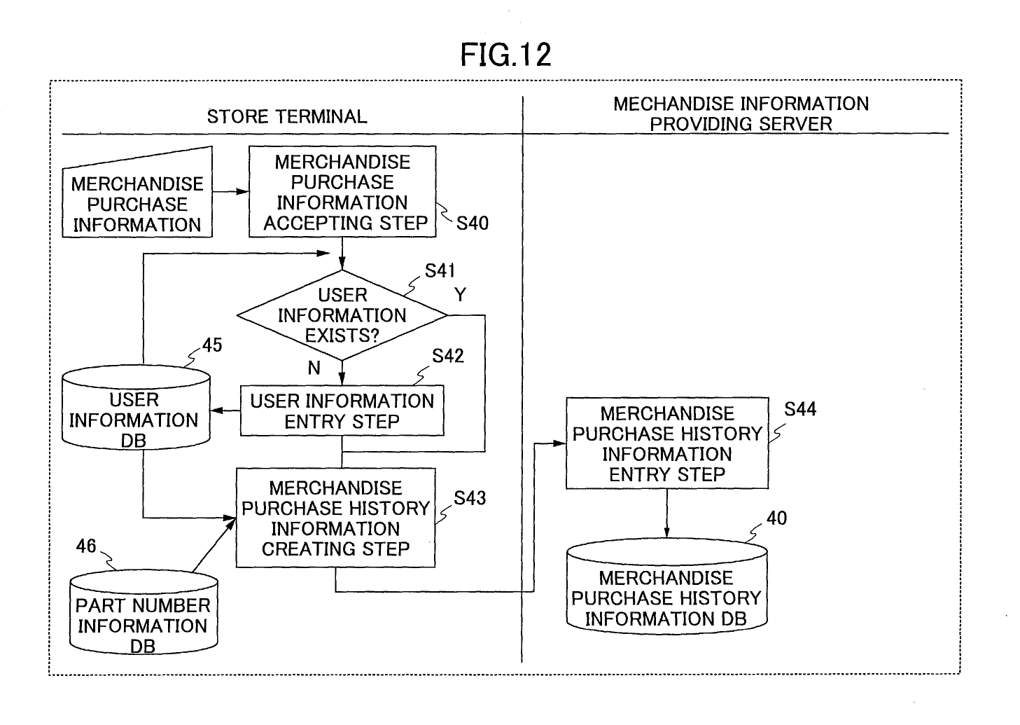

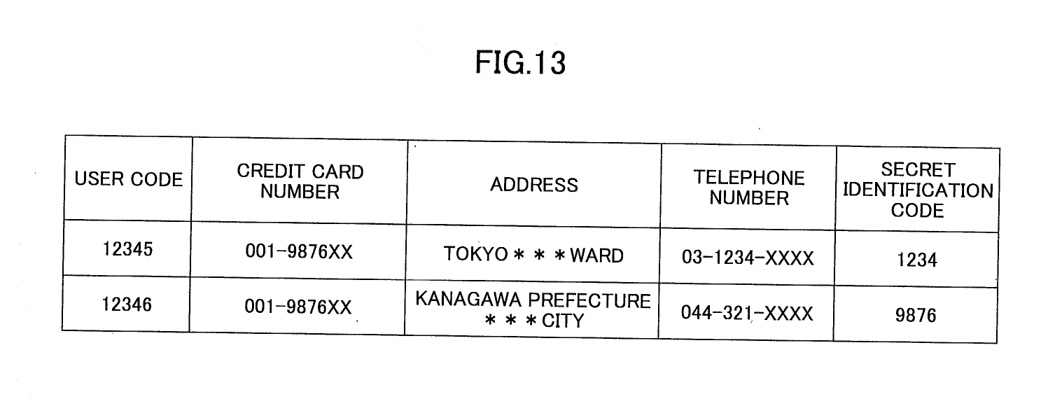

In the following, a description will be given of flow charts in FIGS. 4, 9 and 11. FIG. 12 is a flow chart of an example of the merchandise purchase history information entry process. In step S40, the store terminal 11 accepts merchandise purchase information. Then, the process mentioned above proceeds to step S42 subsequently to step S41, the store terminal 11 obtains the user code included in the merchandise purchase information received in step S40, and determines whether or not the user code obtained exists in a user information DB 45 as shown in FIG. 13.

FIG. 13 is a schematic diagram of an example of the user information DB. The user information DB of FIG. 13 includes fields such as a user code, a credit card number, an address, a telephone number, a secret identification code and the like.

When the store terminal 11 determines that the user code obtained in step S40 is not included in the user information DB 45 (No in step S41), the store terminal 11 regards the user as an unregistered user, and proceeds to step S42. In step S42, the store terminal 11 enters the user information in the user information DB 45 and proceeds to step S43. Further, when the store terminal 11 determines that the user code obtained in step S40 is included in the user information DB 45 (YES in step S41), the store terminal 11 proceeds to step S43.

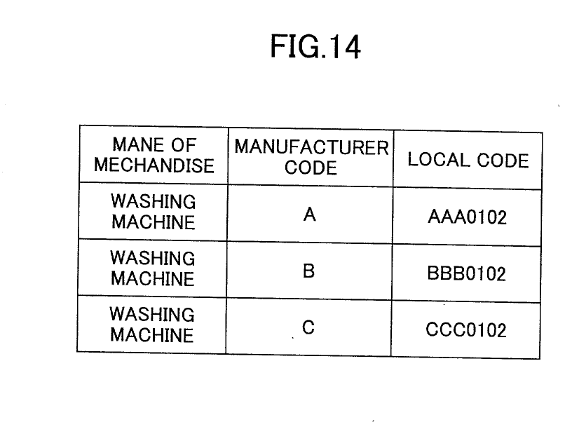

In step S43, the user terminal 11 creates the merchandise purchase history information using the user information DB 45 and a part number information DB 46 as shown in FIG. 14. FIG. 14 is a schematic diagram of an example of the part number information DB. The part number information DB 46 in FIG. 14 includes fields such as a name of merchandise, a manufacturer code, a local code, and the like. Then, the store terminal 11 sends the created merchandise purchase history information to the merchandise information providing server 12.

In step S44, the merchandise information providing server 12 enters the merchandise purchase history information that is received from the store terminal 11 in the merchandise purchase history information DB 40. Accordingly, the merchandise information providing server 12 can enter the merchandise purchase history of the user that purchased the merchandise in the merchandise purchase history information DB 40.

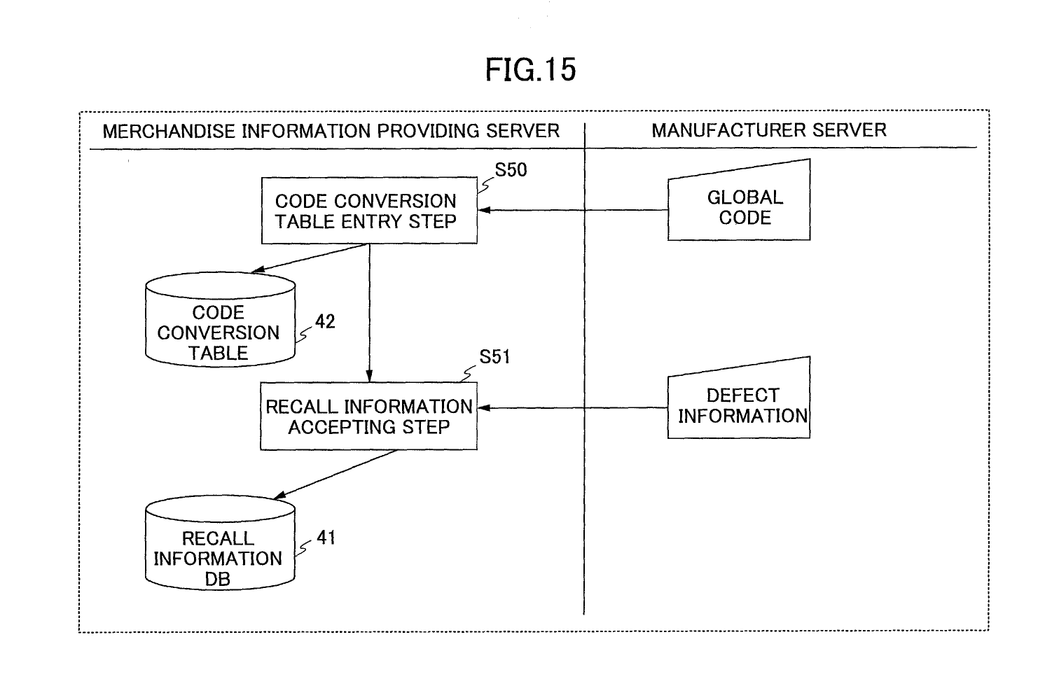

FIG. 15 is a flow chart showing an entry process for the recall information and the code conversion information. Further, the flow chart shows the merchandise information providing server 12 as including the recall information DB 41, that is, the consumer credit company or the like manages the recall information DB 41.

In step S50, the merchandise information providing server 12 receives the global code from the manufacturer server 13. The global code is the merchandise identification information used by the manufacture. For this reason, the merchandise information providing server 12 sets the local code so as to correspond to the global code, relates the input global code to the set local code, and enters the input global code and the set local code in the code conversion table 12. Therefore, the merchandise information providing server 12 can manages the recall information by the local code corresponding to the global code used by the manufacture.

In step S51, the merchandise information providing server 12 accepts the defect information relating to the problem with the merchandise from the manufacturer server 13. The merchandise information providing server 12 enters the received defect information in the recall information DB 41 as the recall information.

Accordingly, the merchandise information providing server 12 can enter the code conversion information in the code conversion table 42, and at the same time, can enter the recall information in the recall information DB 41.

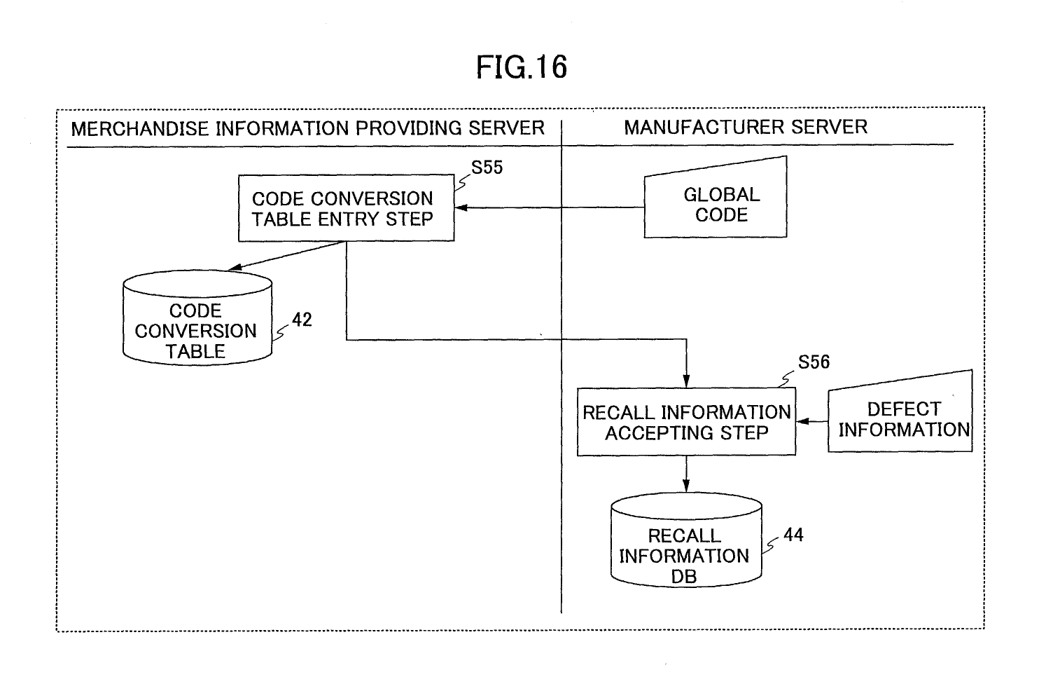

FIG. 16 is a flow chart of an another example of the entry process of the recall information and the code conversion information. Further, the flow chart in FIG. 16 shows an example in which the manufacturer server 13 includes the recall information DB 44, that is, the manufacturer manages the recall information DB 44.

A code conversion table entry process of step S55 is the same as the code conversion table entry process step of S50. Thus, an explanation thereof will be omitted. In step S56, the manufacturer server 13 accepts the defect information relating to the problem with the merchandise from the merchandise information providing server 12. The manufacturer server 13 enters the input defect information in the recall information DB 44 as the recall information.

Accordingly, the merchandise information providing server 12 can enter the code conversion information in the code conversion table 42. In addition, the manufacturer server 13 can enter the recall information in the recall information DB 44.

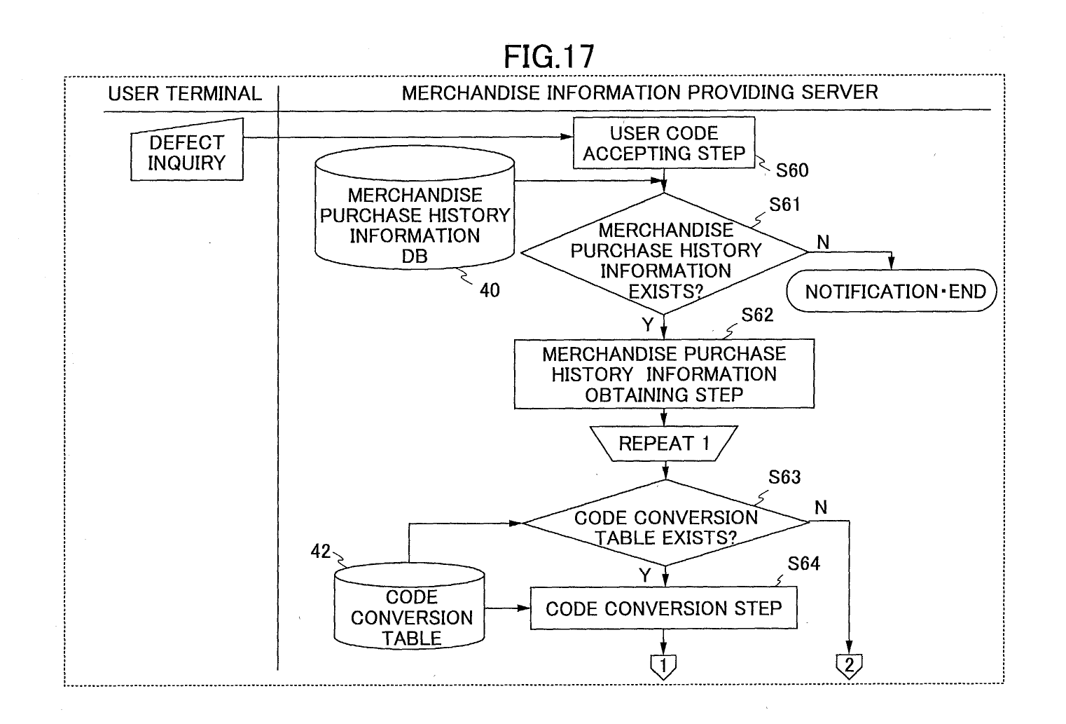

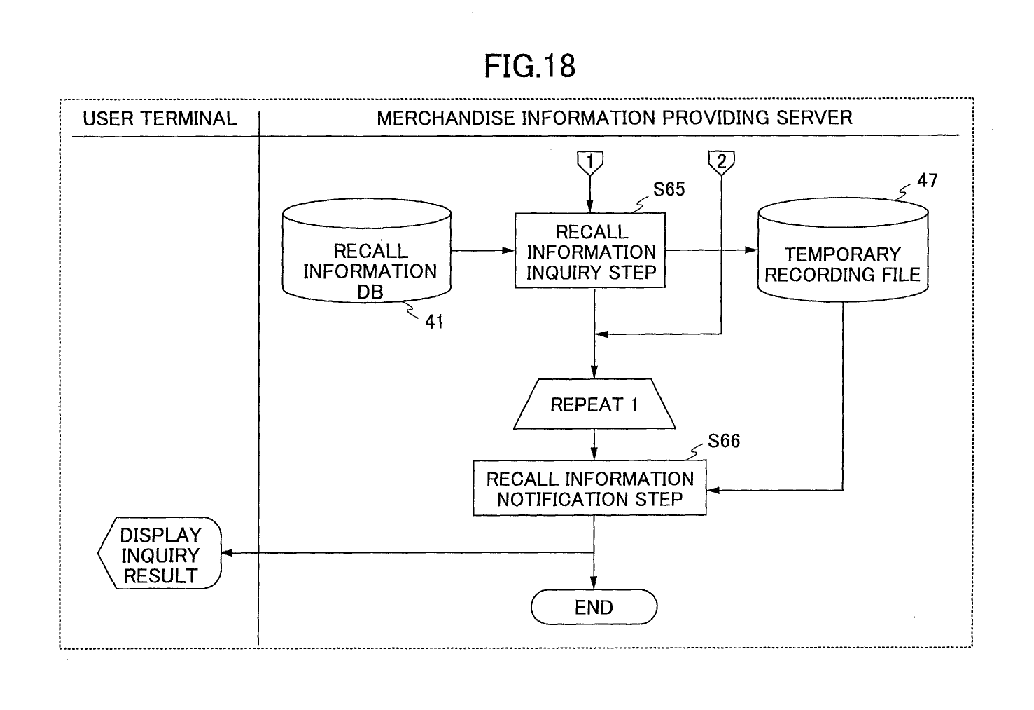

FIGS. 17 and 18 are flow charts of a first embodiment of a recall information inquiry notification process. Further, FIG. 17 shows the first half of the recall information inquiry notification process, and FIG. 18 shows the latter half of the recall information inquiry notification process.

In step S60, the merchandise information providing server 12 accepts the defect inquiry relating to the defect of the merchandise from the user terminal 10. The merchandise information providing server 12 accepts the input defect inquiry. Further, the merchandise information providing server 12 obtains the user code of the user that input the defect inquiry by the authorization process or the like.

In step S61, the merchandise information providing server 12 searches the merchandise purchase history information DB 40 using the user code obtained in step S60 as the key information, and determines whether or not the merchandise purchase history information corresponding to the user code.

When the merchandise information providing server 12 determines that the merchandise purchase history information corresponding to the user code exists (YES in step S61), the merchandise information providing server 12 proceeds to step S62. In step S62, the merchandise information providing server 12 obtains the merchandise purchase history information corresponding to the user code, and proceeds to step S63. Further, when the merchandise information providing server 12 determines that the merchandise purchase history information corresponding to the user code does not exist (No in step S61), the merchandise information providing server 12 notifies the user terminal 10 that the merchandise purchase history information does not exist, and ends the recall information inquiry notification process.

In step S63, the merchandise information providing server 12 determines whether or not the code conversion table corresponding to the merchandise purchase history information obtained in step S62 exists. Specifically, the merchandise information providing server 12 determines whether or not the local code included in the merchandise purchase history information is entered in the code conversion table 42.

When the merchandise information providing server 12 determines that the code conversion table corresponding to the obtained merchandise purchase history information exists (YES in step S63), the merchandise information providing server 12 proceeds to step S64. In step S64, the merchandise information providing server 12 converts the local code included in the obtained merchandise purchase history information into the global code.

In step S65, the merchandise information providing server 12 searches the recall information DB 41 using the global code converted in step S64, and obtains the recall information corresponding to the global code. The merchandise information providing server 12 records the recall information obtained in step S65 in a temporary recording file 47.

When the recall information inquiry step of step S65 is completed, or when the merchandise information providing server 12 determines that the code conversion table corresponding to the obtained merchandise purchase history information does not exist (No in step S63), the merchandise information providing server 12 determines whether the process to be performed on the obtained merchandise purchase history information has ended, and repeats the processes S63 through S65 until the process to be performed on the obtained merchandise purchase history information ends.

The merchandise information providing server 12 proceeds to step S66 when the process to be performed on the obtained merchandise purchase history information has ended. In step S66, the merchandise information providing server 12 reads the recall information from the temporary recording file 47, and provides the read recall information to the user terminal 10. The user terminal 10 can display the notified recall information in the inquiry result window.

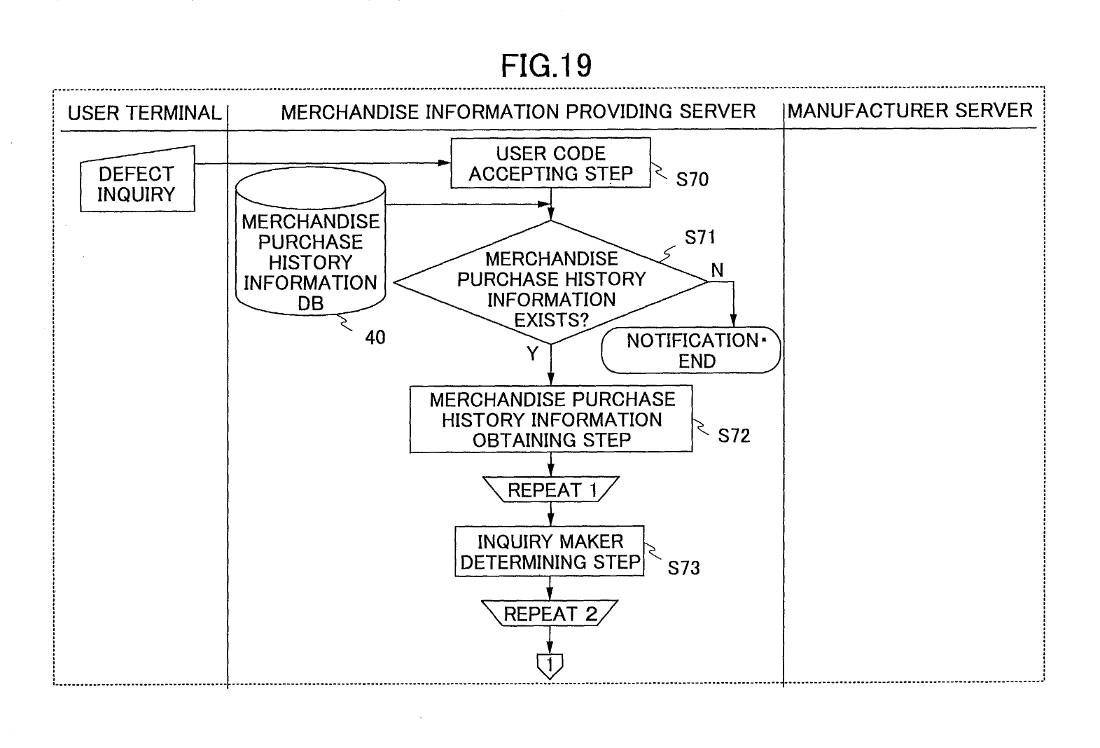

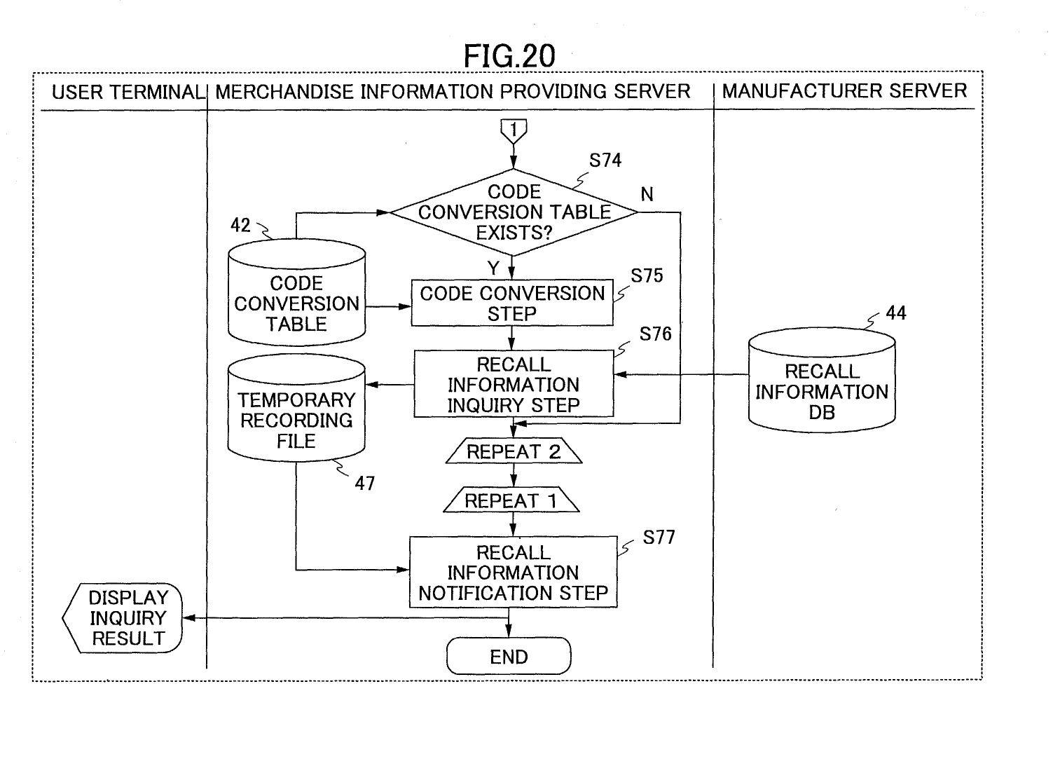

FIGS. 19 and 20 are flow charts of a second embodiment of the recall information inquiry•notification process. Further, FIG. 19 shows the first half of the recall information inquiry notification process, and FIG. 20 shows the latter half of the recall information inquiry•notification process.

The processes of steps S70 through S72 are the same as the processes of the steps S60 through S62. Thus, an explanation thereof will be omitted. In step S73, the merchandise information providing server 12 refers to the manufacturer code in the merchandise purchase history information obtained in step S72, and determines the manufacturer on which the recall information inquiry process is performed.

In step S74, the merchandise information providing server 12 selects the merchandise purchase history information corresponding to the manufacturer determined in step S73 from the merchandise purchase history information obtained in step S72. Then, the merchandise information providing server 12 determines whether or not the code conversion table corresponding to the selected merchandise purchase history information exists.

When the merchandise information providing server 12 determines that the code conversion table corresponding to the selected merchandise purchase history information exists (YES in S74), the merchandise information providing server 12 proceeds to step S75. In step S75, the merchandise information providing server 12 converts the local code included in the selected merchandise purchase history information into the global code.

Step S76 is a recall information inquiry step. In step S76, the merchandise information providing server 12 searches the recall information DB 44 using the global code converted in step S75, and obtains the recall information corresponding to the global code. The merchandise information providing server 12 operates and inquire the recall information DB 44 that the manufacturer manages by using SQL, for example. The merchandise information providing server 12 records the recall information obtained in step S76 in the temporary recording file 47.

When the recall information inquiry step of step S76 has ended, or when the merchandise information providing server 12 determines that the code conversion table corresponding to the selected merchandise purchase history information does not exist (NO in step S74), the merchandise information providing server 12 determines whether the process to the merchandise purchase history information selected in step S74 has ended, and repeats the processes of steps S74 through S76 when the process to the selected merchandise purchase history information has not ended

When the process to the selected merchandise purchase history information has ended, the merchandise information providing server 12 determines whether the process to the merchandise purchase history information obtained in step S72 has ended, and repeats the processes of the steps S73 through S76 until the process to be performed on the obtained merchandise purchase history information ends.

When the process to the merchandise purchase history information obtained in step S72 has ended, the merchandise information providing server 12 reads the recall information from the temporary file 47, and notifies the user terminal 10 of the read recall information. The user terminal 10 can display the inquiry result window 43 corresponding to the notified recall information.

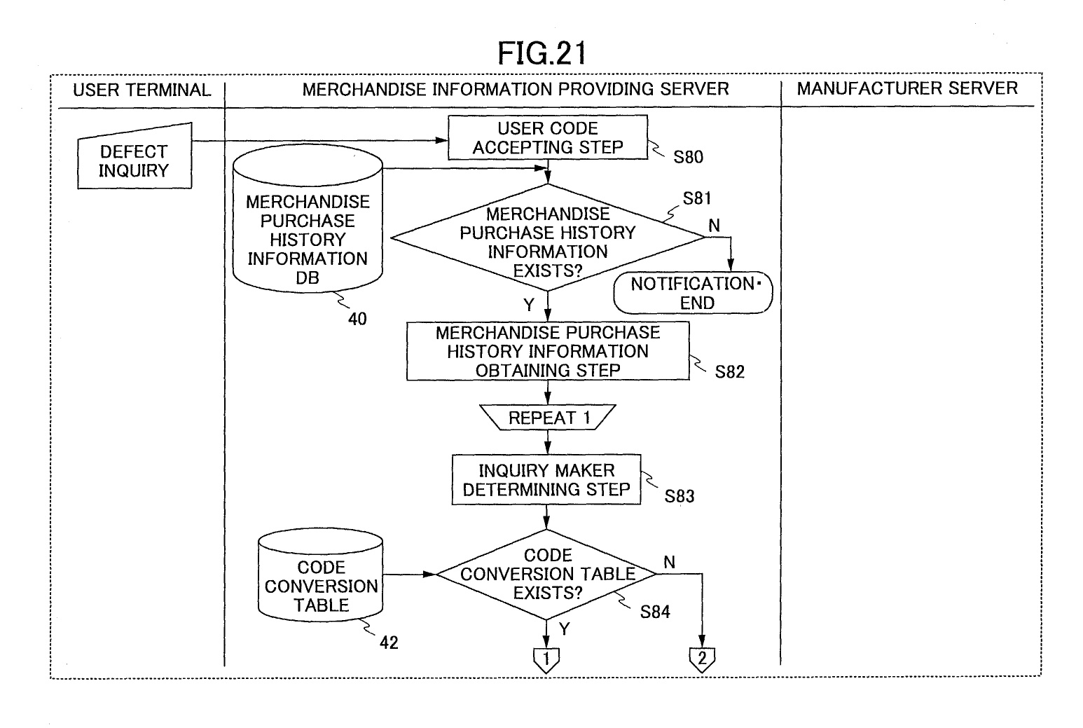

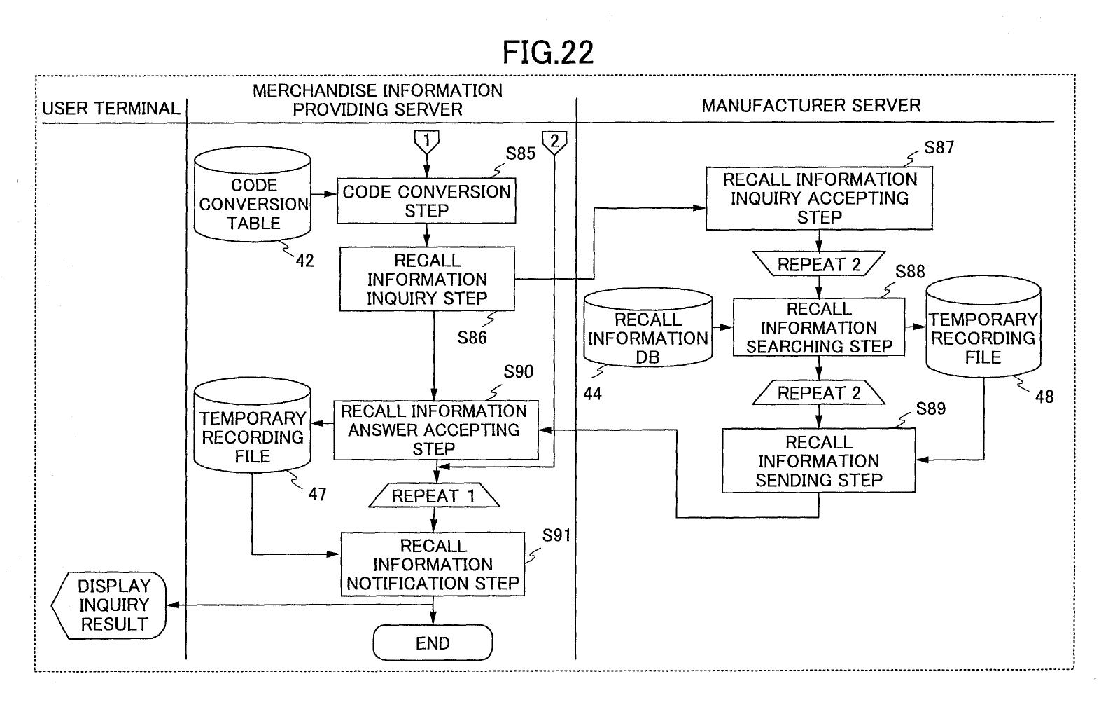

FIGS. 21 and 22 are flow charts of a third embodiment of the recall information inquiry notification process. Further, FIG. 21 shows the first half of the recall information inquiry•notification process, and FIG. 21 shows the latter half of the recall information inquiry•notification process.

The processes of steps S80 through S83 are the same as the processes of the steps S70 through S73. Thus, an explanation thereof will be omitted. In step S84, the merchandise information providing server 12 selects the merchandise purchase history information corresponding to the manufacturer determined in step S83 from the merchandise purchase history information obtained in step S82, and determines whether or not the code conversion table corresponding to the selected merchandise purchase history information exists.

When the merchandise information providing server 12 determines that the code conversion table corresponding to the selected merchandise purchase history information exists (YES in step S84), the merchandise information providing server 12 proceeds to step S85. In step S85, the merchandise information providing server 12 converts the local code included in the selected merchandise purchase history information into the global code.

In step S86, the merchandise information providing server 12 sends the global code converted in step S85 to the manufacturer server 13 as the search condition, and inquires the manufacturer of the recall information. In step S87, the manufacturer server 13 accepts the global code from the merchandise information providing server 12 as the search condition.

In step S88, the manufacturer server 13 searches the recall information DB 44 using the global code as the search condition (key information), and obtains the recall information corresponding to the global code. The manufacturer server 13 enters the recall information obtained in step S88 in a temporary recording file 48.

Further, the manufacturer server 13 determines whether the process to all the global codes accepted in step S87 has ended, and repeats the process of step S88 when the process to all the global codes has not ended.

In step S89, when the process to all the accepted global codes has ended, the manufacturer server 13 reads the recall information from the temporary recording file 48, and sends the read recall information to the merchandise information providing server 12.

Step S90 is a recall information answer accepting step. In step S90, the merchandise information providing server 12 accepts the recall information corresponding to the global code as the search condition from the manufacturer server 13. The merchandise information providing server 12 enters the recall information accepted from the manufacturer server 13 in the temporary recording file 47.

When the recall information answer accepting step of step S90 has ended, or when the merchandise information providing server 12 determines that the code conversion table corresponding to the selected merchandise purchase history information does not exist (No in step S84), the merchandise information providing server 12 determines whether processes of steps S83 through S90 to the merchandise purchase history information obtained in step S82 has ended, and repeats the processes of the steps S83 through S90 when the process to the selected merchandise purchase history information has not ended.

When the processes to the merchandise purchase history information obtained in step S82 have ended, the merchandise information providing server 12 reads the recall information from the temporary file 47, and notifies the user terminal 10 of the read recall information. The user terminal 10 can display the inquiry result window 43 corresponding to the notified recall information.

Further, in the flow charts of FIGS. 21 and 22, an explanation is given of a process in which the merchandise information providing server 12 sends the global codes as one collective set of search conditions to the manufacturer server 13, and accepts the one collective set of recall information as the search results. However, the merchandise information providing server 12 may send the global codes as search conditions one by one, and may accept the recall information as search results one by one.

The present invention is not limited to the specifically disclosed embodiments, and variations and modifications may be made without departing from the scope of the present invention.

The present application is based on Japanese priority application No. 2001-246655 filed on Aug. 15, 2001, the entire contents of which are hereby incorporated by reference.

What is claimed is:

1. A merchandise information providing method of obtaining merchandise information relating to merchandise from a manufacturer and providing the obtained merchandise information to a purchaser who purchases the merchandise, comprising:
a purchase information storing step storing merchandise identification information identifying the merchandise that the purchaser purchases and purchaser identification information identifying the purchaser in a purchase information storing part in a mutually associating manner;
a merchandise information obtaining step searching for and obtaining merchandise information corresponding to the merchandise identification information from a merchandise information storing part having the merchandise information relating to the merchandise that the manufacturer provides; and
a merchandise information providing step providing the obtained merchandise information to a terminal for the purchaser corresponding to the purchaser identification information.

2. The merchandise information providing method as claimed in claim 1, wherein the purchase information storing step stores a place of purchase and a date of purchase in addition to the merchandise identification information so as to make the place of purchase, the date of purchase and the merchandise identification information correspond to the purchaser identification information in the purchase information storing part.

3. The merchandise information providing method as claimed in claim 1, wherein the purchase information storing step comprising the steps of:
a) receiving the merchandise identification information and the purchaser identification information from a seller of the merchandise; and
b) storing the merchandise identification information and the purchaser identification information in the purchase information storing part in a mutually associating manner.

4. The merchandise information providing method as claimed in claim 1, wherein the merchandise information obtaining step searches the merchandise information storing part corresponding to the merchandise identification information and obtains the merchandise information corresponding to the merchandise identification information when the purchaser requests the merchandise information.

5. The merchandise information providing method as claimed in claim 1, wherein the merchandise information obtaining step searches for and obtains the merchandise information corresponding to the merchandise identification information from the merchandise information storing part provided by the manufacturer.

6. The merchandise information providing method as claimed in claim 1, wherein the purchase information storing step stores the merchandise identification information and the purchaser identification information in the purchase information storing part provided by a third-party organization other than the manufacturer in a mutually associating manner.

7. A merchandise information providing software program for causing a computer to perform the following steps:
a) storing merchandise identification information identifying merchandise that a purchaser purchased and purchaser identification information identifying the purchaser in a purchase information storing part in a mutually associating manner;
b) searching for and obtaining merchandise information corresponding to the merchandise identification information from a merchandise information storing part having the merchandise information relating to the merchandise that a manufacturer provides; and
c) providing the obtained merchandise information to a terminal for the purchaser corresponding to the purchaser identification information.

8. A computer readable recording medium recording a merchandise information providing software program for causing a computer to perform the following steps:
a) storing merchandise identification information identifying merchandise that a purchaser purchases and purchaser identification information identifying the purchaser in a purchase information storing part in a mutually associating manner;
b) searching for and obtaining merchandise information corresponding to the merchandise identification information from a merchandise information storing part having the merchandise information relating to the merchandise that a manufacturer provides; and
c) providing the obtained merchandise information to a terminal for the purchaser corresponding to the purchaser identification information.

9. A merchandise information providing server that obtains merchandise information relating to merchandise from a manufacturer and provides the obtained merchandise information to a purchaser who purchases the merchandise, comprising:
a purchase information storing part storing merchandise identification information identifying the merchandise that the purchaser purchases and purchaser identification information identifying the purchaser in a mutually associating manner;
a merchandise information obtaining part searching for and obtaining merchandise information corresponding to the merchandise identification information from a merchandise information storing part having the merchandise information relating to the merchandise that the manufacturer provides; and
a merchandise information providing step providing the obtained merchandise information to a terminal for the purchaser corresponding to the purchaser identification information.
